(19) United States
(12) Patent Application Publication
(10) Pub. No.: US 2024/0202990 A1
(43) Pub. Date: Jun. 20, 2024

(54) DATA GENERATION METHOD, LEARNING METHOD, IMAGING APPARATUS, AND PROGRAM

(71) Applicant: FUJIFILM Corporation, Tokyo (JP)

(72) Inventors: Yuya NISHIO, Saitama-shi (JP); Toshiki KOBAYASHI, Saitama-shi (JP)

(73) Assignee: FUJIFILM Corporation, Tokyo (JP)

(21) Appl. No.: 18/420,311

(22) Filed: Jan. 23, 2024

Related U.S. Application Data
(63) Continuation of application No. PCT/JP2022/022229, filed on May 31, 2022.

(30) Foreign Application Priority Data
Aug. 31, 2021 (JP) 2021-141805

(51) Int. Cl. G06T 11/00; H04N 9/73

(52) U.S. Cl. CPC G06T 11/001; H04N 9/73

(57) ABSTRACT

There is a data generation method of generating first image data which is image data obtained by imaging a subject via an imaging apparatus and used in machine learning and which includes accessory information. The data generation method includes a first generation step of generating the first image data by performing first image processing via the imaging apparatus, and a second generation step of generating first information based on image processing information related to the first image processing, as information included in the accessory information.

### CROSS-REFERENCE TO RELATED APPLICATIONS

This application is a continuation application of International Application No. PCT/JP2022/022229, filed May 31, 2022, the disclosure of which is incorporated herein by reference in its entirety. Further, this application claims priority from Japanese Patent Application No. 2021-141805, filed Aug. 31, 2021, the disclosure of which is incorporated herein by reference in its entirety.

### BACKGROUND

### 1. Technical Field

A technology of the present disclosure relates to a data generation method, a learning method, an imaging apparatus, and a program.

### 2. Related Art

JP2018-152804A discloses a method of estimating a three dimensional geometric transformation in a three dimensional RGB color space for RGB data extracted from an image obtained by imaging a color chart by a statistically optimal method in which a covariance matrix of errors is taken into consideration. JP2018-152804A discloses a method of performing color matching between various cameras of different types which have imaged a scene including the color chart by determining an optimum model which balances the complexity and the goodness of fit of a model by geometric model selection from estimation results of a plurality of geometric transformation models with different degrees of freedom, and calculating color correction processing by selected three dimensional geometric transformation by three dimensional lookup table interpolation.

JP1997-284581A (JP-H9-284581A) discloses a color simulation apparatus comprising first to fourth conversion means and output means. The first conversion means is means for representing each color of a subject by at least three feature parameters and feature parameter coefficients obtained by performing multivariate analysis on a spectral reflectance distribution or a spectral transmittance distribution that does not depend on a light source. The first conversion means converts an input color information value into at least three feature parameter coefficients corresponding to the color information value. The second conversion means converts the at least three feature parameter coefficients from the first conversion means into a spectral reflectance signal or a spectral transmittance signal by at least three feature parameter signals obtained by the multivariate analysis. The third conversion means converts a spectral reflectance distribution or the spectral transmittance distribution converted by the second conversion means into a color value signal based on the spectral information of the designated light source. The fourth conversion means consists of a plurality of neural networks, and has a function of training, at the time of preparation, a neural network by giving a color value for each light source of a standard color sample of which a color separation value output from a printer in advance is known as an input and giving the color separation value of the standard color sample as a teacher signal, and a function of outputting, at the time of conversion, the color separation value by selectively inputting the color value of which information of the light source from the third conversion means is known into the trained network for each light source. The output means outputs a current image by the color separation value converted by the fourth conversion means.

### SUMMARY

An embodiment according to the technology of the present disclosure provides a data generation method, a learning method, an imaging apparatus, and a program capable of reducing a variation due to image processing in an image quality of an image indicated by image data subjected to the image processing.

A first aspect according to the technology of the present disclosure relates to a data generation method of generating first image data which is image data obtained by imaging a subject via an imaging apparatus and used in machine learning and which includes accessory information, the data generation method comprising: a first generation step of generating the first image data by performing first image processing via the imaging apparatus; and a second generation step of generating first information based on image processing information related to the first image processing, as information included in the accessory information.

A second aspect according to the technology of the present disclosure relates to an imaging apparatus comprising: an image sensor; and a processor, in which the processor generates first image data used in machine learning by performing first image processing on an imaging signal generated by imaging a subject via the image sensor, and generates first information based on image processing information related to the first image processing, as information included in accessory information of the first image data.

A third aspect according to the technology of the present disclosure relates to a program for causing a computer to execute data generation processing of generating first image data which is image data obtained by imaging a subject via an imaging apparatus and used in machine learning and which includes accessory information, the data generation processing comprising: generating the first image data by performing first image processing via the imaging apparatus; and generating first information based on image processing information related to the first image processing, as information included in the accessory information.

### BRIEF DESCRIPTION OF THE DRAWINGS

Exemplary embodiments according to the technique of the present disclosure will be described in detail based on the following figures, wherein:

FIG. 1 is a schematic configuration diagram showing an example of an overall configuration of an information processing system;

FIG. 2 is a schematic configuration diagram showing an example of a hardware configuration of an electrical system of an imaging apparatus;

FIG. 3 is a schematic configuration diagram showing an example of a hardware configuration of an electrical system of an information processing apparatus;

FIG. 4 is a conceptual diagram showing an example of a processing content of a first generation unit;

FIG. 5 is a conceptual diagram showing an example of processing contents of second image processing and third image processing;

FIG. 6 is a conceptual diagram showing an example of a processing content of a second generation unit;

FIG. 7 is a conceptual diagram showing an example of processing contents of the first generation unit and an operation unit;

FIG. 8 is a conceptual diagram showing an example of a processing content of a teacher data generation unit;

FIG. 9 is a conceptual diagram showing an example of a processing content of a learning execution unit;

FIG. 10 is a flowchart showing an example of a flow of data generation processing;

FIG. 11 is a flowchart showing an example of a flow of machine learning processing;

FIG. 12 is a conceptual diagram showing an example of the processing content of the second generation unit in a case where a color chart with more types of color patches than a color chart shown in FIG. 6 is used;

FIG. 13 is a conceptual diagram showing an example of the processing content of the operation unit in a case where a color chart with more types of color patches than a color chart shown in FIG. 7 is used;

FIG. 14 is a conceptual diagram showing an example of processing contents in the imaging apparatus and an information processing apparatus in a case where color chart information used in the imaging apparatus and reference color information used in the information processing apparatus are the same information; and

FIG. 15 is a conceptual diagram showing a modification example of a generation method of the color chart information.

### DETAILED DESCRIPTION

An example of embodiments of a data generation method, a learning method, an imaging apparatus, and a program according to the technology of the present disclosure will be described below with reference to accompanying drawings.

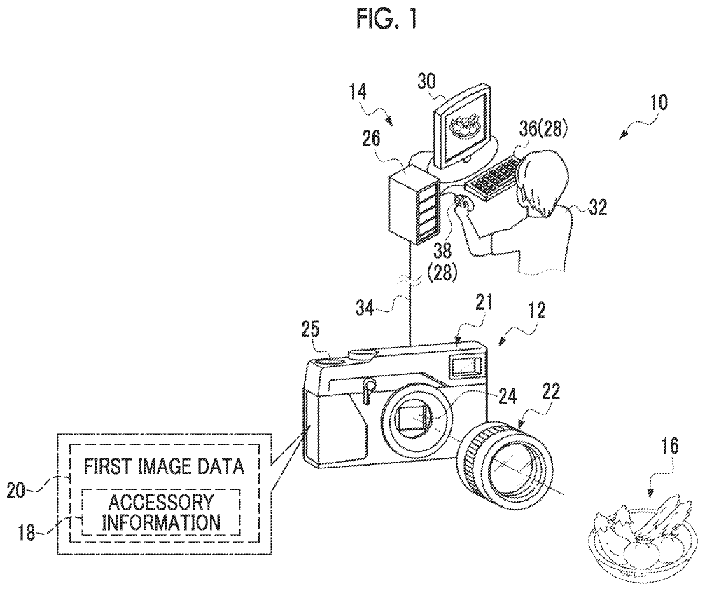

As shown in FIG. 1 as an example, an information processing system 10 comprises an imaging apparatus 12 and an information processing apparatus 14. The imaging apparatus 12 and the information processing apparatus 14 are communicably connected to each other. It should be noted that, in the present embodiment, the imaging apparatus 12 is an example of an “imaging apparatus” according to the technology of the present disclosure.

The imaging apparatus 12 images a subject 16 to generate first image data 20 including accessory information 18. The first image data 20 is image data used in machine learning. The machine learning is executed by, for example, the information processing apparatus 14. Although details will be described below, the accessory information 18 is metadata related to the first image data 20.

The imaging apparatus 12 comprises an imaging apparatus body 21 and an interchangeable lens 22. The interchangeable lens 22 is interchangeably mounted on the imaging apparatus body 21. In the example shown in FIG. 1, a lens-interchangeable digital camera is shown as an example of the imaging apparatus 12.

However, this is merely an example, and a digital camera with a fixed lens may be used, or a digital camera mounted on various electronic apparatuses, such as a smart device, a wearable terminal, a cell observation apparatus, an ophthalmic observation apparatus, and a surgical microscope, may be used.

An image sensor 24 is provided in the imaging apparatus body 21. The image sensor 24 is an example of an “image sensor” according to the technology of the present disclosure. The image sensor 24 is a complementary metal oxide semiconductor (CMOS) image sensor.

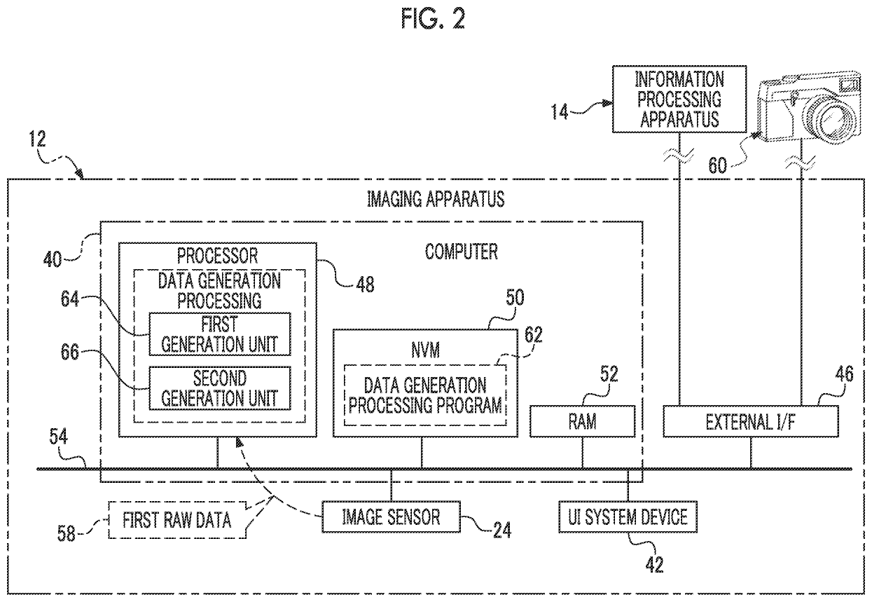

A release button 25 is provided on an upper surface of the imaging apparatus body 21. In a case where the release button 25 is operated by a user, the image sensor 24 images an imaging range including the subject 16. In a case where the interchangeable lens 22 is mounted on the imaging apparatus body 21, subject light indicating the subject 16 is transmitted through the interchangeable lens 22 and forms an image on the image sensor 24, and analog image data 56 (refer to FIG. 2) indicating an image of the subject 16 is generated by the image sensor 24.

In the present embodiment, the CMOS image sensor is described as the image sensor 24, but the technology of the present disclosure is not limited to this, and for example, the technology of the present disclosure is established even in a case where the image sensor 24 is another type of an image sensor, such as a charge coupled device (CCD) image sensor.

The information processing apparatus 14 is an apparatus used in the machine learning. The information processing apparatus 14 comprises a computer 26, a reception device 28, and a display 30, and is used by an annotator 32. The annotator 32 refers to an operator (that is, an operator who performs labeling) who gives an annotation for machine learning to given data.

The imaging apparatus body 21 is communicably connected to the computer 26. In the example shown in FIG. 1, the imaging apparatus body 21 and the computer 26 are connected via a communication cable 34. It should be noted that, in the example shown in FIG. 1, a form example is shown in which the imaging apparatus body 21 and the computer 26 are connected by wire, but the technology of the present disclosure is not limited to this, and the connection between the imaging apparatus body 21 and the computer 26 may be a wireless connection.

The reception device 28 is connected to the computer 26. The reception device 28 includes a keyboard 36, a mouse 38, and the like, and receives an instruction from the annotator 32.

As shown in FIG. 2 as an example, the imaging apparatus 12 comprises a computer 40, a user interface (UI) system device 42, an analog/digital (A/D) converter 44, and an external interface (I/F) 46, in addition to the image sensor 24.

The computer 40 is an example of a “computer” according to the technology of the present disclosure. The computer 40 comprises a processor 48, a non-volatile memory (NVM) 50, and a random access memory (RAM) 52.

The processor 48, the NVM 50, and the RAM 52 are connected to a bus 54. The image sensor 24, the UI system device 42, the A/D convertor 44, and the external I/F 46 are also connected to the bus 54.

The processor 48 is an example of a “processor” according to the technology of the present disclosure. The processor 48 controls the entire imaging apparatus 12. The processor 48 is, for example, a processing apparatus including a central processing unit (CPU) and a graphics processing unit (GPU), and the GPU operates under the control of the CPU and is responsible for executing processing related to an image.

Here, a processing apparatus including the CPU and the GPU is described as an example of the processor 48, but this is merely an example, and the processor 48 may be one or more CPUs into which a GPU function is integrated, or may be one or more CPUs into which a GPU function is not integrated.

The NVM 50 is a non-volatile storage device that stores various programs, various parameters, and the like. Examples of the NVM 50 include a flash memory (for example, an electrically erasable and programmable read only memory (EEPROM)). The RAM 52 is a memory that transitorily stores information, and is used as a work memory by the processor 48. Examples of the RAM 52 include a dynamic random access memory (DRAM) and a static random access memory (SRAM).

The UI system device 42 is a device having a reception function of receiving an instruction signal indicating an instruction from the user and a presentation function of presenting the information to the user. The reception function is realized by, for example, a touch panel and a hard key (for example, the release button 25 and a menu selection key). The presentation function is realized by, for example, a display and a speaker.

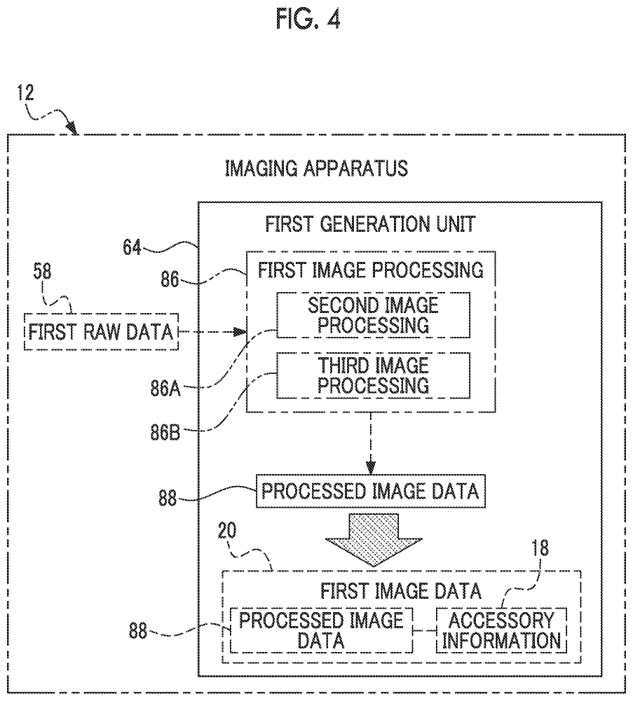

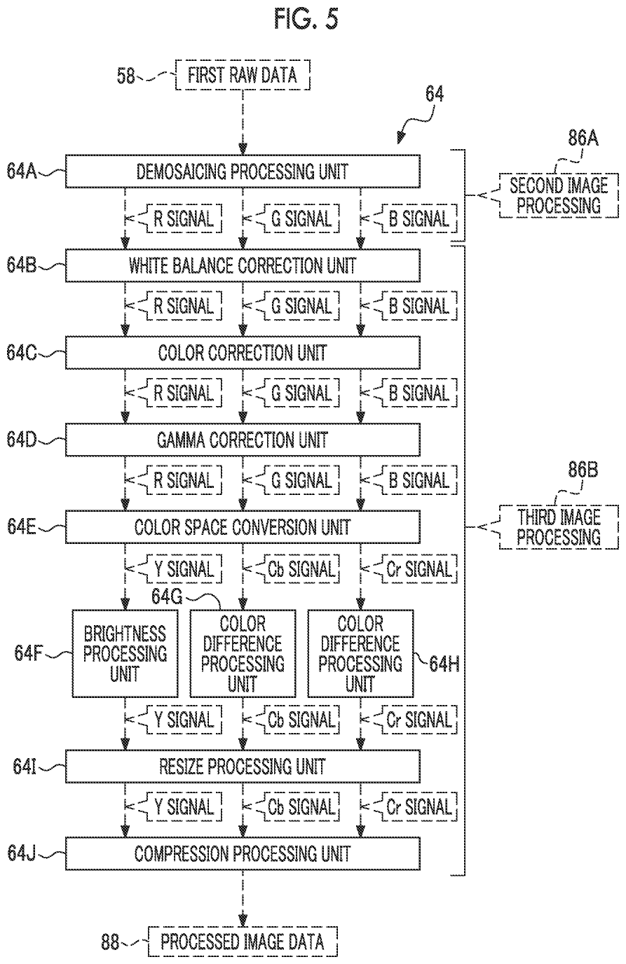

The image sensor 24 images the subject 16 (refer to FIG. 1) under the control of the processor 48. An A/D convertor (not shown) is incorporated in the image sensor 24, and first raw image format (RAW) data 58, which is RAW data, is generated by digitizing the analog image data obtained by the imaging via the image sensor 24. The first RAW data 58 is data indicating an image in which red (R) pixels, green (G) pixels, and blue (B) pixels are arranged in a mosaic pattern. The processor 48 acquires the first RAW data 58 from the A/D convertor 44, and performs first image processing 86 (refer to FIGS. 4 and 5) including demosaicing processing or the like on the acquired first RAW data 58. It should be noted that the first RAW data 58 is an example of an “imaging signal” according to the technology of the present disclosure.

The external I/F 46 controls exchange of various types of information between a device existing outside the imaging apparatus 12 (hereinafter, also referred to as an “external device”) and the processor 48. Examples of the external I/F 46 include a universal serial bus (USB) interface. The information processing apparatus 14, a reference imaging apparatus 60, a smart device, a personal computer, a server, a USB memory, a memory card, a printer, or like is directly or indirectly connected to the external I/F 46 as the external device. Examples of the reference imaging apparatus 60 include an imaging apparatus having a function corresponding to the imaging apparatus 12.

An image quality of the image indicated by the image data obtained by imaging the subject 16 (refer to FIG. 1) via each of a plurality of imaging apparatuses (for example, a plurality of imaging apparatuses manufactured by different manufacturers) including the imaging apparatus 12 may vary due to a difference in a parameter used in the image processing performed in each imaging apparatus even though the same type of image processing is performed between the imaging apparatuses. For example, in a case where a white balance gain (hereinafter, also referred to as a “WB gain”) used in the white balance correction processing is different between the imaging apparatuses, a tint is different between the respective images obtained by imaging the subject 16 via each imaging apparatus. In addition to the difference in the tint between the respective images, an image having a tint completely different from an original tint of the subject 16 (refer to FIG. 1) may be obtained depending on various parameters used in the image processing of the imaging apparatus.

In view of such circumstances, the imaging apparatus 12 is configured such that the processor 48 performs data generation processing (refer to FIGS. 4 to 7 and FIG. 10). The data generation processing is realized by the processor 48 operating as a first generation unit 64 and a second generation unit 66 in accordance with a data generation processing program 62. The data generation processing program 62 is an example of a “program” according to the technology of the present disclosure.

In the example shown in FIG. 2, the data generation processing program 62 is stored in the NVM 50. The processor 48 reads out the data generation processing program 62 from the NVM 50 to execute the read out data generation processing program 62 on the RAM 52. The processor 48 performs the data generation processing by operating as the first generation unit 64 and the second generation unit 66 in accordance with the data generation processing program 62 executed on the RAM 52.

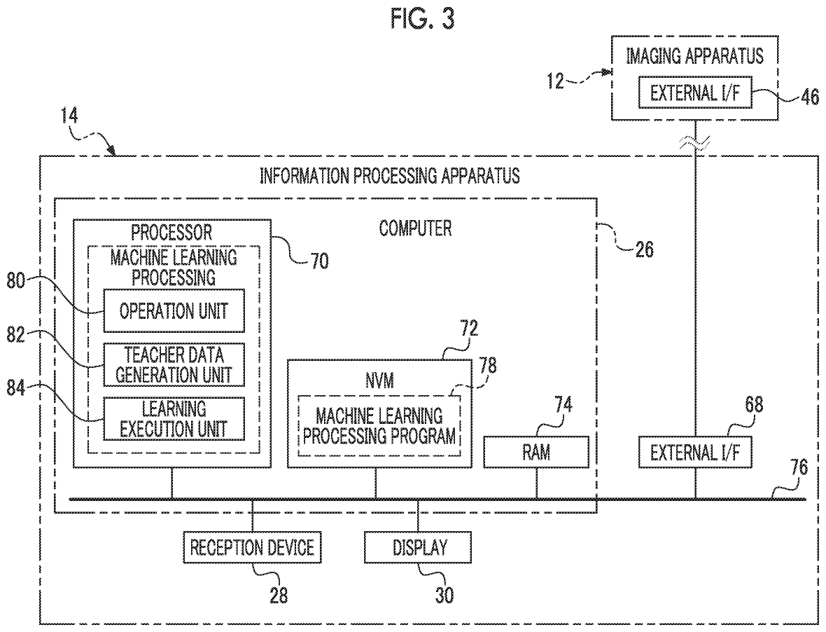

As shown in FIG. 3 as an example, the information processing apparatus 14 comprises an external I/F 68 in addition to the computer 26, the reception device 28, and the display 30.

The computer 26 comprises a processor 70, an NVM 72, and an RAM 74. The processor 70, the NVM 72, and the RAM 74 are connected to a bus 76. The reception device 28, the display 30, and the external I/F 68 are also connected to the bus 76.

The processor 70 controls the entire information processing apparatus 14. The processor 70, the NVM 72, and the RAM 74 are the same hardware resources as the processor 48, the NVM 50, and the RAM 52 which are described above.

The reception device 28 receives the instruction from the annotator 32 (refer to FIG. 1). The processor 70 operates in accordance with the instruction received by the reception device 28.

The external I/F 68 is the same hardware resource as the external I/F 46 described above. The external I/F 68 is connected to the external I/F 46 of the imaging apparatus 12, and controls exchange of various types of information between the imaging apparatus 12 and the processor 70.

A machine learning processing program 78 is stored in the NVM 72. The processor 70 reads out the machine learning processing program 78 from the NVM 72 to execute the read out machine learning processing program 78 on the RAM 74. The processor 70 performs machine learning processing in accordance with the machine learning processing program 78 executed on the RAM 74. The machine learning processing is realized by the processor 70 operating as an operation unit 80, a teacher data generation unit 82, and a learning execution unit 84 in accordance with the machine learning processing program 78.

As shown in FIG. 4 as an example, the first generation unit 64 performs the first image processing 86 on the first RAW data 58 to generate the first image data 20. Here, a step of generating the first image data 20 is an example of a “first generation step” according to the technology of the present disclosure.

The first image processing 86 includes second image processing 86A, which is processing of a part of the first image processing 86, and third image processing 86B, which is processing of a part of the first image processing 86. Here, the second image processing 86A is an example of “second image processing corresponding to processing of a part of the first image processing” according to the technology of the present disclosure.

The first generation unit 64 performs the first image processing 86 (for example, the second image processing 86A and the third image processing 86B) on the first RAW data 58 to generate processed image data 88, and associates accessory information 18 with the generated processed image data 88 to generate the first image data 20.

As shown in FIG. 5 as an example, the first generation unit 64 comprises a demosaicing processing unit 64A, a white balance correction unit 64B, a color correction unit 64C, a gamma correction unit 64D, a color space conversion unit 64E, a brightness processing unit 64F, a color difference processing unit 64G, a color difference processing unit 64H, a resize processing unit 64I, and a compression processing unit 64J.

Examples of the second image processing 86A include processing performed by the demosaicing processing unit 64A.

Examples of the third image processing 86B include processing performed by the white balance correction unit 64B, processing performed by the color correction unit 64C, processing performed by the gamma correction unit 64D, processing performed by the color space conversion unit 64E, processing performed by the brightness processing unit 64F, processing performed by the color difference processing unit 64G, processing performed by the color difference processing unit 64H, processing performed by the resize processing unit 64I, and processing performed by the compression processing unit 64J.

The demosaicing processing unit 64A performs the demosaicing processing on the first RAW data 58. The demosaicing processing is processing of converting the first RAW data 58 into three plates of R, G, and B. That is, the demosaicing processing unit 64A performs color interpolation processing on an R signal, a G signal, and a B signal included in the first RAW data 58 to generate R image data indicating an image corresponding to R, B image data indicating an image corresponding to B, and G image data indicating an image corresponding to G. Here, the color interpolation processing refers to processing of interpolating a color that each pixel does not have, from peripheral pixels. That is, since each photosensitive pixel of a photoelectric conversion element 24A (refer to FIG. 2) can obtain only the R signal, the G signal, and the B signal (that is, a signal value corresponding to a pixel of one color of R, G, or B), the demosaicing processing unit 64A interpolates other colors which cannot be obtained in each pixel by using signal values of surrounding pixels. It should be noted that, hereinafter, the R image data, the B image data, and the G image data are also referred to as “RGB image data”.

The white balance correction unit 64B performs the white balance correction processing on the RGB image data obtained by performing the demosaicing processing. The white balance correction processing is processing of correcting an influence of a color of a light source type on color signals of RGB by multiplying the color signals of RGB by the WB gain set for each of the R pixel, the G pixel, and the B pixel. The WB gain is, for example, a gain for white. Examples of the gain for white include a gain determined such that the signal levels of the R signal, the G signal, and the B signal are equal to each other for a white subject shown in the image. For example, the WB gain is set in accordance with the light source type specified by performing the image analysis, or is set in accordance with the light source type designated by the user or the like.

The color correction unit 64C performs color correction processing (here, for example, color correction by a linear matrix) on the RGB image data subjected to the white balance correction processing. The color correction processing is processing of adjusting hue and color saturation characteristics. Examples of the color correction processing include processing of changing the color reproducibility by multiplying the RGB image data by a color reproduction coefficient (for example, a linear matrix coefficient). It should be noted that the color reproduction coefficient is a coefficient determined such that the spectral characteristics of R, G, and B approximate human visibility characteristics.

The gamma correction unit 64D performs gamma correction processing on the RGB image data subjected to the color correction processing. The gamma correction processing is processing of correcting the gradation of an image indicated by the RGB image data in accordance with a value indicating response characteristics of the gradation of the image, that is, a gamma value.

The color space conversion unit 64E performs color space conversion processing on the RGB image data subjected to the color correction processing. The color space conversion processing is processing of converting a color space of the RGB image data subjected to the color correction processing from an RGB color space to an YCbCr color space. That is, the color space conversion unit 64E converts the RGB image data into brightness/color difference signals. The brightness/color difference signals are a Y signal, a Cb signal, and a Cr signal. The Y signal is a signal indicating the brightness. Hereinafter, the Y signal may be referred to as a brightness signal. The Cb signal is a signal obtained by adjusting a signal obtained by subtracting a brightness component from the B signal. The Cr signal is a signal obtained by adjusting a signal obtained by subtracting the brightness component from the R signal. Hereinafter, the Cb signal and the Cr signal may be referred to as color difference signals. The brightness processing unit 64F performs brightness filter processing on the Y signal. The brightness filter processing is processing of filtering the Y signal by using a brightness filter (not shown). For example, the brightness filter is a filter that reduces high-frequency noise generated in the demosaicing processing or emphasizes sharpness. The signal processing on the Y signal, that is, the filtering by the brightness filter is performed in accordance with a brightness filter parameter. The brightness filter parameter is a parameter set for the brightness filter. The brightness filter parameter defines a degree of reduction of the high-frequency noise generated in the demosaicing processing and a degree of emphasis of the sharpness. The brightness filter parameter is changed in accordance with, for example, an imaging condition or the instruction signal received by the UI system device 42 (refer to FIG. 2).

The color difference processing unit 64G performs first color difference filter processing on the Cb signal. The first color difference filter processing is processing of filtering the Cb signal by using a first color difference filter (not shown). For example, the first color difference filter is a low pass filter that reduces the high-frequency noise included in the Cb signal. The signal processing on the Cb signal, that is, the filtering by the first color difference filter is performed in accordance with a designated first color difference filter parameter. The first color difference filter parameter is a parameter set for the first color difference filter. The first color difference filter parameter defines a degree of reduction of the high-frequency noise included in the Cb signal. The first color difference filter parameter is changed in accordance with, for example, the imaging condition or the instruction signal received by the UI system device 42 (refer to FIG. 2).

The color difference processing unit 64H performs second color difference filter processing on the Cr signal. The second color difference filter processing is processing of filtering the Cr signal by using a second color difference filter (not shown). For example, the second color difference filter is a low pass filter that reduces the high-frequency noise included in the Cr signal. The signal processing for the Cr signal, that is, the filtering by the second color difference filter is performed in accordance with a designated second color difference filter parameter. The second color difference filter parameter is a parameter set for the second color difference filter. The second color difference filter parameter defines a degree of reduction of the high-frequency noise included in the Cr signal. The second color difference filter parameter is changed in accordance with, for example, the imaging condition or the instruction signal received by the UI system device 42 (refer to FIG. 2).

The resize processing unit 64I performs resize processing to the brightness/color difference signals. The resize processing is processing of adjusting the brightness/color difference signals such that a size of the image indicated by the brightness/color difference signals matches a size designated by the user or the like.

The compression processing unit 64J performs compression processing on the brightness/color difference signals subjected to the resize processing. The compression processing is, for example, processing of compressing the brightness/color difference signals in accordance with a predetermined compression method. Examples of the predetermined compression method include joint photographic experts group (JPEG), tagged image file format (TIFF), and joint photographic experts group extended range (JPEG XR). The processed image data 88 is obtained by performing the compression processing on the brightness/color difference signals. The compression processing unit 64J stores the processed image data 88 in a predetermined storage device (for example, the RAM 52 (refer to FIG. 2)).

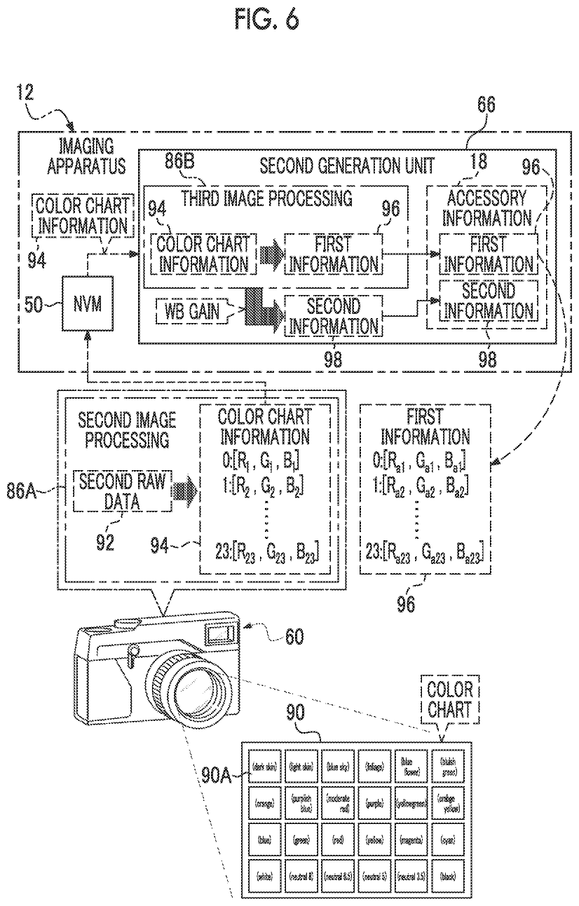

As shown in FIG. 6 as an example, the reference imaging apparatus 60 generates second RAW data 92 by imaging a color chart 90. The second RAW data 92 is an example of a “color chart imaging signal” according to the technology of the present disclosure.

The color chart 90 includes a plurality of color patches 90A. In the example shown in FIG. 6, a plate-shaped object on which rectangular 24-colored color patches 90A are arranged is shown as an example of the color chart 90. The second RAW data 92 is RAW data obtained by the reference imaging apparatus 60 performing the same processing as the processing performed by the imaging apparatus 12 to obtain the first RAW data 58.

The reference imaging apparatus 60 performs the second image processing 86A on the second RAW data 92 to generate color chart information 94 indicating the color chart 90. For example, the color chart information 94 is represented as the signal values of R, G, and B (as an example, output values for each pixel of 256 gradations of 0 to 255) for each of the plurality of color patches 90A (for example, 24-colored color patches 90A). That is, the color chart information 94 is information in which the plurality of color patches 90A are defined as the signal values of R, G, and B. Here, the signal value of R is an example of a “first signal value indicating a first primary color” according to the technology of the present disclosure, the signal value of G is an example of a “second signal value indicating a second primary color” according to the technology of the present disclosure, and the signal value of B is an example of a “third signal value indicating a third primary color” according to the technology of the present disclosure.

The color chart information 94 obtained in this way is stored in advance in the imaging apparatus 12. In the example shown in FIG. 6, the color chart information 94 is stored in advance in the NVM 50.

The second generation unit 66 generates first information 96 as information included in the accessory information 18. The first information 96 is information based on image processing information (hereinafter, also simply referred to as “image processing information”) related to the first image processing 86 (refer to FIG. 4). Here, a step of generating the first information 96 is an example of a “second generation step” according to the technology of the present disclosure.

Examples of the image processing information include various parameters used in the third image processing 86B. Examples of the various parameters include the WB gain used in the white balance correction processing, the gamma value used in the gamma correction processing, the color reproduction coefficient used in the color correction processing, a conversion coefficient used in the color space conversion processing, the brightness filter parameter used in the brightness filter processing, the first color difference filter parameter used in the first color difference filter processing, the second color difference filter parameter used in the second color difference filter processing, the parameter used in the resize processing, and the parameter used in the compression processing. It should be noted that the image processing information may be image processing information that does not take a part of the first image processing 86 into consideration. For example, the image processing information may be information that does not take the white balance correction processing into consideration.

The first information 96 is information based on the color chart information 94 and the image processing information. In other words, the first information 96 is color information derived from the color chart information 94. Examples of the color information derived from the color chart information 94 include information obtained by changing the signal values of R, G, and B representing the color chart information 94 by adding the image processing information to the signal values of R, G, and B representing the color chart information 94.

The first information 96, that is, the information based on the color chart information 94 and the image processing information is obtained, for example, by performing the third image processing 86B, which is processing of a part of the first image processing 86, on the color chart information 94. In the example shown in FIG. 6, the second generation unit 66 acquires the color chart information 94 from the NVM 50, and performs the third image processing 86B on the acquired color chart information 94 to generate the first information 96. The first information 96 is represented as the signal values of R, G, and B for each of the plurality of color patches 90A (as an example, 24-colored color patches 90A).

The second generation unit 66 generates second information 98 as the information included in the accessory information 18. The second information 98 is information related to the gain used in the white balance correction processing included in the third image processing 86B. In the present embodiment, the WB gain used in the white balance correction processing performed on the color chart information 94 is applied as the second information 98.

It should be noted that this is merely an example, and the signal value itself used to calculate the WB gain may be applied, or any information related to the gain used in the white balance correction processing need only be applied.

In the example shown in FIG. 6, the first information 96 and the second information 98 are shown as the information included in the accessory information 18, but the technology of the present disclosure is not limited to this, and the accessory information 18 may further include subject detection area information for specifying an area in which the subject 16 (refer to FIG. 1) is detected by performing subject detection processing (for example, subject detection processing of an artificial intelligence (AI) method or a template matching method) via the imaging apparatus 12, designated area information for specifying an area designated in the image indicated by the processed image data 88, and the like.

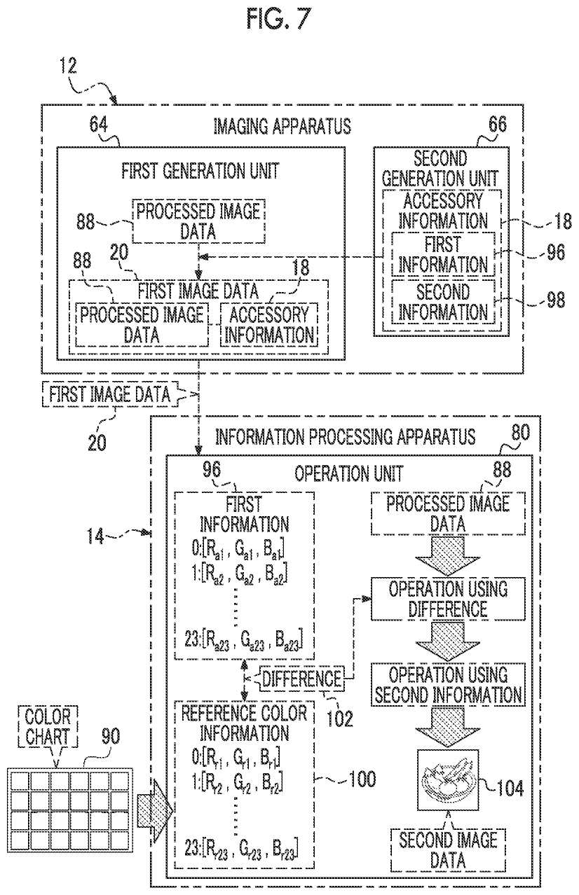

As shown in FIG. 7 as an example, the first generation unit 64 acquires the accessory information 18 including the first information 96 and the second information 98 from the second generation unit 66, and associates the acquired accessory information 18 with the processed image data 88 to generate the first image data 20. The first generation unit 64 transmits the generated first image data 20 to the information processing apparatus 14.

The information processing apparatus 14 receives the first image data 20 transmitted from the first generation unit 64. In the information processing apparatus 14, the operation unit 80 generates second image data 104 by performing an operation using the accessory information 18, on the first image data 20. For example, the second image data 104 is generated by performing an operation using a result of comparison between the first information 96 included in the accessory information 18 and reference color information 100 that is information indicating a reference color of the color chart 90, on the first image data 20. Here, a step of generating the second image data 104 is an example of a “third generation step” according to the technology of the present disclosure.

In a case where the operation unit 80 generates the second image data 104, the operation unit 80 acquires the reference color information 100. For example, the reference color information 100 is stored in advance in the NVM 72 (refer to FIG. 3), and is acquired by the operation unit 80. The reference color information 100 is information represented as the signal values of R, G, and B for each of the plurality of color patches 90A (as an example, 24-colored color patches 90A). The reference color information 100 may be information widely known as a general standard, or may be information obtained by measuring the color of the color chart 90 via a color measurement device (not shown). Here, the “reference color” is, for example, a color approximate to a color perceived by human eyes or a color suitable for machine learning of AI.

In a case where the operation unit 80 generates the second image data 104, the operation unit 80 acquires the first image data 20 generated by the first generation unit, and extracts the processed image data 88, the first information 96, and the second information 98 from the acquired first image data 20. The operation unit 80 calculates a difference 102 between the first information 96 and the reference color information 100. Examples of the difference 102 include a difference for each color patch in the color chart 90. Here, the difference 102 is described, but the difference 102 is merely an example, and instead of the difference 102, a ratio of one of the first information 96 or the reference color information 100 to the other may be applied, and any value may be applied as long as the value indicates a degree of difference between the first information 96 and the reference color information 100.

The operation unit 80 generates corrected processed image data 88 by performing an operation using the difference 102 on the processed image data 88 by performing an operation using the first information 96. That is, the operation using the difference 102 is performed on the processed image data 88, so that the processed image data 88 is converted into the corrected processed image data 88. The operation using the difference 102 for the processed image data 88 refers to, for example, an operation of multiplying, in units of pixels, the processed image data 88 by a coefficient required to match the first information 96 with the reference color information 100 or a coefficient required to make the first information 96 approximate the reference color information 100. As a result, the color of the image indicated by the processed image data 88 can be made to approximate the color of the reference color.

Since the color chart information 94 (refer to FIG. 6) is generated by imaging the color chart 90 with an appropriate white light source, it is not necessary to suppress a change in color due to the light source in the white balance correction processing. On the other hand, since the first image data 20 indicating the image obtained by actual imaging is image data obtained by imaging under various light sources (that is, environmental light), it is important to perform the white balance correction processing to obtain a natural color in which an influence of the light source is suppressed. However, as in FIG. 7, in a case where the correction of making the color of the image indicated by the first image data 20 approximate the color of the reference color based on the first information 96 is performed, the effect of the white balance correction processing executed by the imaging apparatus 12 is canceled, and as a result, the image data indicating the image in which the reference color is changed due to the influence of the color of the light source is generated. The reason is that the first information 96 is generated based on the third image processing 86B including the white balance correction processing.

Then, the operation unit 80 generates the second image data 104 by correcting the corrected processed image data 88 by performing an operation using the second information 98 on the processed image data 88 corrected by performing the operation using the difference 102. As a result, the second image data 104 indicating the image in which the color of the light source is suppressed and is made to approximate the reference color is generated. The operation using the second information 98 for the processed image data 88 refers to an operation of multiplying, in units of pixels, the processed image data 88 by a coefficient required to match the tint obtained by performing the white balance correction processing on the processed image data 88 with the tint obtained by performing the white balance correction processing on the color chart information 94, or a coefficient required to make the tint obtained by performing the white balance correction processing on the processed image data 88 approximate the tint obtained by performing the white balance correction processing on the color chart information 94.

It should be noted that, in FIG. 6, the first information 96 is generated based on information on the third image processing 86B including the white balance correction processing. However, in a case where the first information 96 is generated without taking the white balance correction processing in the third image processing 86B into consideration, the operation using the second information 98 for the corrected processed image data 88 in FIG. 7 may be skipped.

As described above, the image indicated by the second image data 104 has a color made to approximate the reference color. Therefore, even with a plurality of second image data 104 based on a plurality of first image data 20 generated by imaging apparatuses different from each other (that is, imaging apparatuses having different contents of the image processing), the variation in color between the imaging apparatuses is reduced by making the color of each image indicated by each second image data 104 approximate the reference color. Therefore, as compared to a case where the contents of the image processing of the different imaging apparatuses are not taken into consideration at all, a color standard is unified in the second image data 104, which is suitable for teacher data of AI.

The operation unit 80 generates the second image data 104 by performing the operation using the difference 102 on the processed image data 88 corrected by performing the operation using the second information 98. That is, the processed image data 88 is converted into the second image data 104 by performing the operation using the difference 102 on the processed image data 88. The operation using the difference 102 for the processed image data 88 refers to, for example, an operation of multiplying, in units of pixels, the processed image data 88 by a coefficient required to match the first information 96 with the reference color information 100 or a coefficient required to make the first information 96 approximate the reference color information 100.

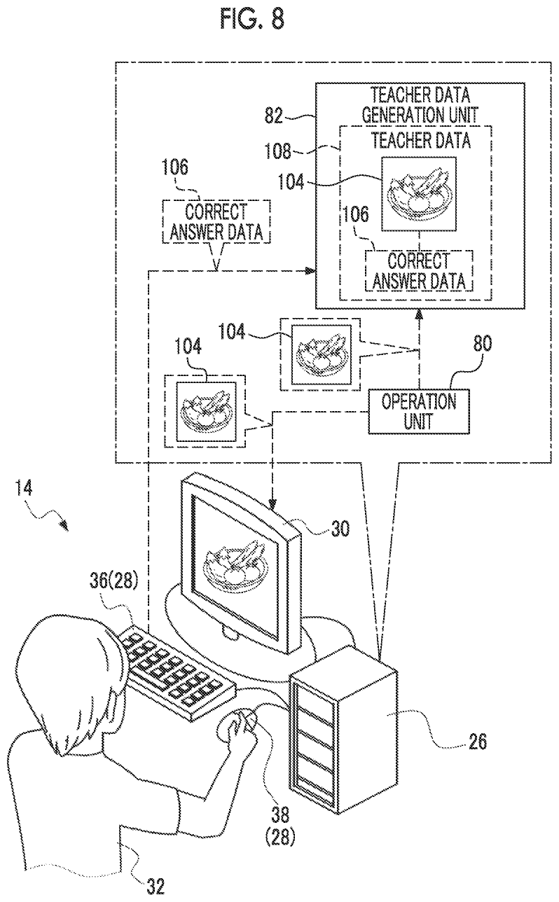

As shown in FIG. 8 as an example, the operation unit 80 causes the display 30 to display the image indicated by the second image data 104. In this state, the annotator 32 gives correct answer data 106 related to the second image data 104 to the computer 26 via the reception device 28. The correct answer data 106 includes, for example, position specification information (for example, coordinates) for specifying a position of the designated region in the image indicated by the second image data 104 and subject information (for example, information indicating the name of the subject) for specifying the subject included as an image in the region specified from the position specification information. The teacher data generation unit 82 acquires the second image data 104 from the operation unit 80 and associates the correct answer data 106 given from the annotator 32 with the acquired second image data 104 to generate teacher data 108.

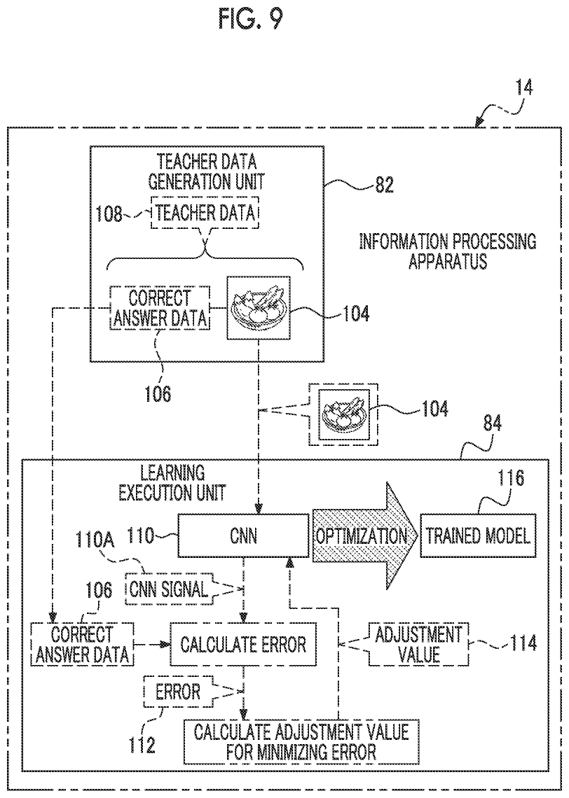

As shown in FIG. 9 as an example, in the information processing apparatus 14, the learning execution unit 84 acquires the teacher data 108 generated by the teacher data generation unit 82. Then, the learning execution unit 84 executes the machine learning by using the teacher data 108.

In the example shown in FIG. 9, the learning execution unit 84 includes a convolutional neural network (CNN) 110. The learning execution unit 84 inputs the second image data 104 included in the teacher data 108 to the CNN 110. In a case where the second image data 104 is input, the CNN 110 performs an inference, and outputs a CNN signal 110A indicating a result of the inference. The learning execution unit 84 calculates an error 112 between the CNN signal 110A and the correct answer data 106 included in the teacher data 108.

The learning execution unit 84 calculates a plurality of adjustment values 114 for minimizing the error 112. Then, the learning execution unit 84 optimizes the CNN 110 by adjusting a plurality of optimizing variables in the CNN 110 by using the plurality of adjustment values 114. Here, the plurality of optimizing variables refer to, for example, a plurality of connection weights and a plurality of offset values included in the CNN 110.

The learning execution unit 84 repeatedly performs learning processing of inputting the second image data 104 to the CNN 110, calculating the error 112, calculating the plurality of adjustment values 114, and adjusting the plurality of optimizing variables in the CNN 110, by using a plurality of teacher data 108. That is, the learning execution unit 84 optimizes the CNN 110 by adjusting the plurality of optimizing variables in the CNN 110 by using the plurality of adjustment values 114 calculated such that the error 112 is minimized for each of the plurality of second image data 104 included in the plurality of teacher data 108. A trained model 116 is generated by the CNN 110 in this way. The trained model 116 is stored in a predetermined storage device by the learning execution unit 84. Examples of the predetermined storage device include the NVM 72 of the information processing apparatus 14 (refer to FIG. 3) and the NVM 50 of the imaging apparatus 12. The trained model 116 stored in the predetermined storage device is used in, for example, the AI method subject detection processing by the imaging apparatus 12.

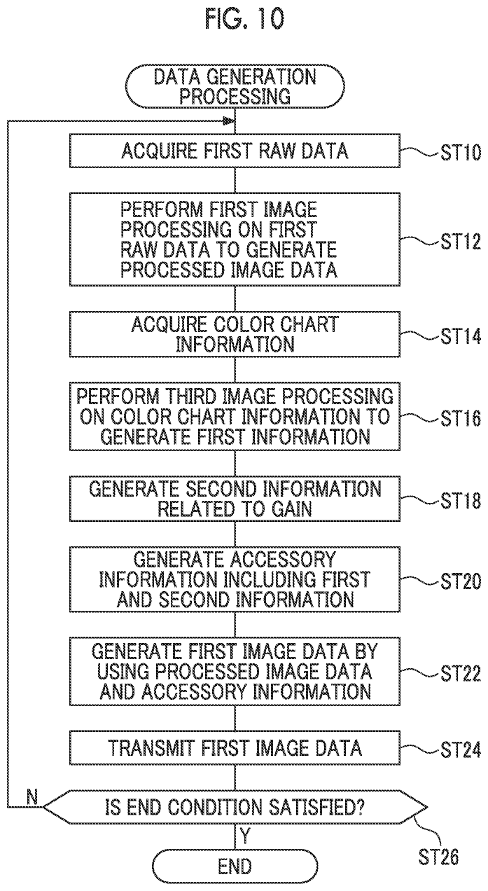

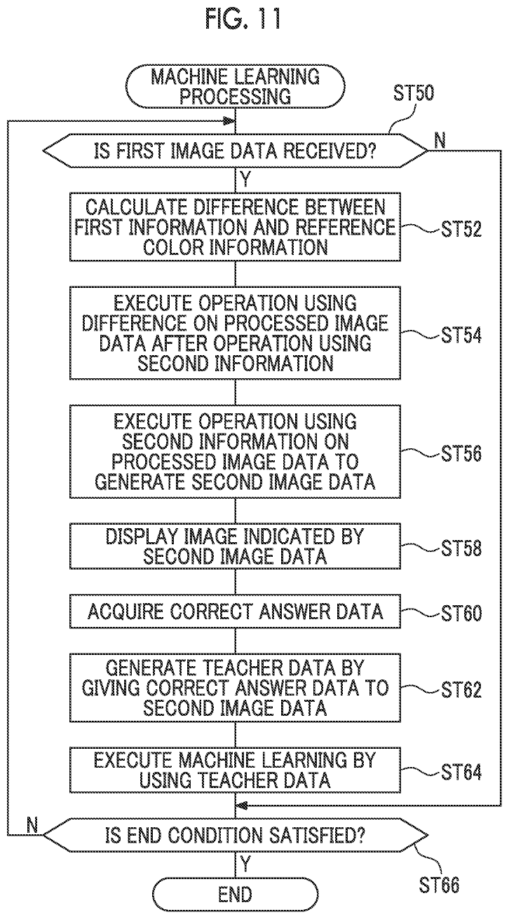

Next, the action of the information processing system 10 will be described with reference to FIGS. 10 and 11.

First, an example of a flow of the data generation processing executed by the processor 48 of the imaging apparatus 12 will be described with reference to FIG. 10. The flow of the data generation processing shown in FIG. 10 is an example of a “data generation method” according to the technology of the present disclosure.

In the data generation processing shown in FIG. 10, first, in step ST10, the first generation unit 64 acquires the first RAW data 58 (refer to FIG. 4). After the processing of step ST10 is executed, the data generation processing transitions to step ST12.

In step ST12, the first generation unit 64 performs the first image processing 86 on the first RAW data 58 acquired in step ST10 to generate the processed image data 88 (refer to FIGS. 4 and 5). After the processing of step ST12 is executed, the data generation processing transitions to step ST14.

In step ST14, the second generation unit 66 acquires the color chart information 94 from the NVM 50 (refer to FIG. 6). After the processing of step ST14 is executed, the data generation processing transitions to step ST16.

In step ST16, the second generation unit 66 performs the third image processing 86B on the color chart information 94 acquired in step ST14 to generate the first information 96 (refer to FIG. 6). After the processing of step ST16 is executed, the data generation processing transitions to step ST18.

In step ST18, the second generation unit 66 generates the information related to the gain used in the white balance correction processing included in the third image processing 86B performed in step ST16, as the second information 98 (refer to FIG. 6). After the processing of step ST18 is executed, the data generation processing transitions to step ST20.

In step ST20, the second generation unit 66 generates the accessory information 18 including the first information 96 generated in step ST16 and the second information 98 generated in step ST18 (refer to FIG. 6). After the processing of step ST20 is executed, the data generation processing transitions to step ST22.

In step ST22, the first generation unit 64 generates the first image data 20 by using the processed image data 88 generated in step ST12 and the accessory information 18 generated in step ST20 (refer to FIG. 7). After the processing of step ST22 is executed, the data generation processing transitions to step ST24.

In step ST24, the first generation unit 64 transmits the first image data 20 generated in step ST22 to the information processing apparatus 14 (refer to FIG. 7). After the processing of step ST24 is executed, the data generation processing transitions to step ST26.

In step ST26, the first generation unit 64 determines whether or not a condition for ending the data generation processing (hereinafter, referred to as a “data generation processing end condition”) is satisfied. Examples of the data generation processing end condition include a condition that an instruction to end the data generation processing is received by the UI system device 42 (refer to FIG. 2) or the reception device 28 (refer to FIG. 3). In a case where the data generation processing end condition is not satisfied in step ST26, a negative determination is made, and the data generation processing transitions to step ST10. In step ST26, in a case where the data generation processing end condition is satisfied, an affirmative determination is made, and the data generation processing ends.

Next, an example of a flow of the machine learning processing executed by the processor 70 of the information processing apparatus 14 will be described with reference to FIG. 11. The flow of the machine learning processing shown in FIG. 11 is an example of a “learning method” according to the technology of the present disclosure.

In the machine learning processing shown in FIG. 11, first, in step ST50, the operation unit 80 determines whether or not the first image data 20 transmitted to the information processing apparatus 14 by executing the processing of step ST24 included in the data generation processing shown in FIG. 10 is received by the external I/F 68 (refer to FIG. 3). In step ST50, in a case where the first image data 20 is not received by the external I/F 68, a negative determination is made, and the machine learning processing transitions to step ST66. In step ST50, in a case where the first image data 20 is received by the external I/F 68, an affirmative determination is made, and the machine learning processing transitions to step ST52.

In step ST52, the operation unit 80 calculates the difference 102 between the first information 96 included in the first image data 20 received by the external I/F 68 in step ST50 and the reference color information 100 (refer to FIG. 7). After the processing of step ST52 is executed, the machine learning processing transitions to step ST54.

In step ST54, the operation unit 80 generates the second image data 104 by executing the operation using the difference 102 calculated in step ST50 on the processed image data 88 received by the external I/F 68 in step ST52 (refer to FIG. 7). After the processing of step ST54 is executed, the machine learning processing transitions to step ST56.

In step ST56, the operation unit 80 corrects the processed image data 88 by performing the operation using the second information 98 included in the first image data 20 on the processed image data 88 after the operation using the difference 102, to generate the second image data 104 (refer to FIG. 7). After the processing of step ST56 is executed, the machine learning processing transitions to step ST58.

In step ST58, the operation unit 80 causes the display 30 to display the image indicated by the second image data 104 generated in step ST56 (refer to FIG. 8). After the processing of step ST58 is executed, the machine learning processing transitions to step ST60.

In step ST60, the teacher data generation unit 82 acquires the correct answer data 106 received by the reception device 28 (refer to FIG. 8). After the processing of step ST60 is executed, the machine learning processing transitions to step ST62.

In step ST62, the teacher data generation unit 82 generates the teacher data 108 by giving the correct answer data 106 acquired in step ST56 to the second image data 104 generated in step ST60 (refer to FIG. 9). After the processing of step ST62 is executed, the machine learning processing transitions to step ST64.

In step ST64, the learning execution unit 84 optimizes the CNN 110 by executing the machine learning by using the teacher data 108 generated in step ST62. The CNN 110 is optimized to generate the trained model 116 (refer to FIG. 9). After the processing of step ST64 is executed, the machine learning processing transitions to step ST66.

In step ST66, the learning execution unit 84 determines whether or not a condition for ending the machine learning processing (hereinafter, referred to as a “machine learning processing end condition”) is satisfied. Examples of the machine learning processing end condition include a condition that an instruction to end the machine learning processing is received by the reception device 28 (refer to FIG. 3). In step ST66, in a case where the machine learning processing end condition is not satisfied, a negative determination is made, and the machine learning processing transitions to step ST50. In step ST66, in a case where the machine learning processing end condition is satisfied, an affirmative determination is made, and the machine learning processing ends.

As described above, in the information processing system 10 according to the present embodiment, the first image processing 86 is performed on the first RAW data 58 by the first generation unit 64 of the imaging apparatus 12 to generate the first image data 20 (refer to FIG. 4). The first image data 20 includes the accessory information 18 (refer to FIG. 4). The first information 96 based on the image processing information related to the first image processing 86 is generated as the information included in the accessory information 18 by the second generation unit 66 of the imaging apparatus 12 (refer to FIG. 6). The accessory information 18 including the first information 96 generated in this way is used in the correction of the processed image data 88 included in the first image data 20, and as a result, the second image data 104 is generated (refer to FIG. 7). That is, the second image data 104 is generated by correcting the processed image data 88 such that the first information 96 is information related to a predetermined image quality (for example, the reference color information 100). The image quality (for example, color) of the image indicated by the second image data 104 generated in this way approximates a reference image quality (for example, reference color) as compared to the image indicated by the processed image data 88 before the correction. In a case where the image quality of the image indicated by the second image data 104 can be made to approximate the reference image quality, even though the plurality of second image data 104 are generated by different imaging apparatuses (for example, between imaging apparatuses having different contents of image processing), the variation in image quality due to the first image processing 86 between the different imaging apparatuses is reduced. Accordingly, with the present configuration, it is possible to reduce the variation due to the first image processing 86 (for example, the variation due to the first image processing 86 between different imaging apparatuses) in the image quality of the image indicated by the second image data 104, as compared to a case where the first image data 20 in which the first image processing 86 is performed on the first RAW data 58 includes only information completely unrelated to the first image processing 86, as the accessory information.

In the information processing system 10 according to the present embodiment, information based on the color chart information 94 indicating the color chart 90 and the image processing information related to the first image processing 86 is generated as the first information 96 included in the accessory information 18 by the second generation unit 66 of the imaging apparatus 12. The accessory information 18 including the first information 96 generated in this way is used in the correction of the processed image data 88 included in the first image data 20, and as a result, the second image data 104 is generated (refer to FIG. 7). That is, the second image data 104 is generated by correcting the processed image data 88 such that the first information 96 is information related to a predetermined color. The color of the image indicated by the second image data 104 generated in this way approximates the reference color as compared to the image indicated by the processed image data 88 before the correction. In a case where the color of the image indicated by the second image data 104 can be made to approximate the reference color, even though the plurality of second image data 104 are generated by different imaging apparatuses (for example, between imaging apparatuses having different contents of image processing), the variation in color due to the first image processing 86 between the different imaging apparatuses is reduced. Accordingly, with the present configuration, it is possible to reduce the variation due to the first image processing 86 (for example, the variation due to the first image processing 86 between different imaging apparatuses) in the color of the image indicated by the second image data 104, as compared to a case where the first image data 20 obtained by performing the first image processing 86 on the first RAW data 58 includes only information completely unrelated to the first image processing 86 and the color chart 90, as the accessory information.

In the information processing system 10 according to the present embodiment, the color information derived from the color chart information 94 (for example, information obtained by adding the image processing information to the signal values of R, G, and B representing the color chart information 94) is generated by the second generation unit 66 of the imaging apparatus 12, as the first information 96 included in the accessory information 18. The accessory information 18 including the first information 96 generated in this way is used in the correction of the processed image data 88 included in the first image data 20, and as a result, the second image data 104 is generated (refer to FIG. 7). That is, the second image data 104 is generated by correcting the processed image data 88 such that the color information derived from the color chart information 94 is information related to a predetermined color. In a case where the color of the image indicated by the second image data 104 can be made to approximate the reference color, even though the plurality of second image data 104 are generated by different imaging apparatuses (for example, between imaging apparatuses having different contents of image processing), the variation in image quality due to the first image processing 86 between the different imaging apparatuses is reduced. Therefore, with the present configuration, it is possible to reduce the variation due to the first image processing 86 (for example, the variation due to the first image processing 86 between different imaging apparatuses) in the color of the image indicated by the second image data 104, as compared to a case where the processed image data 88 is corrected by using only information other than the color information derived from the color chart information 94.

In the information processing system 10 according to the present embodiment, the color chart information 94 is stored in advance in the NVM 50 of the imaging apparatus 12. Therefore, with the present configuration, it is possible to correct the processed image data 88 by using the first information 96 and the second information 98 without performing the color measurement on the color chart 90 each time the first information 96 and the second information 98 are generated.

In the information processing system 10 according to the present embodiment, the information in which the plurality of color patches 90A (refer to FIG. 6) are defined based on the signal values of R, G, and B is used as the color chart information 94. Accordingly, with the present configuration, the color chart information 94 and the first information 96 generated based on the color chart information 94 are detailed information, as compared to a case where the color chart information indicating the color chart is information defined only by the signal value of R, the signal value of G, or the signal value of B. Accordingly, in the step of generating the second image data 104 based on the first information 96 generated based on the color chart information 94 and the second information 98, the color of the image indicated by the second image data 104 can be made to approximate the reference color more accurately.

In the information processing system 10 according to the present embodiment, the information obtained by performing the second image processing 86A corresponding to the processing of a part of the first image processing 86 on the second RAW data 92 obtained by imaging the color chart 90 via the reference imaging apparatus 60 is used as the color chart information 94 (refer to FIG. 6). Since the color chart information 94 is information that is a reference for generating the first information 96 by using the third image processing 86B, it is preferable that the color chart information 94 is created by using the image processing of a part of the first image processing 86 corresponding to all the image processing. Therefore, with the present configuration, it is possible to reduce the variation due to the second image processing 86A in the color of the image indicated by the second image data 104, as compared to a case where the information obtained by performing the image processing completely unrelated to the second image processing 86A on the second RAW data 92 is used as the color chart information.

In the information processing system 10 according to the present embodiment, the second information 98 related to the gain used in the white balance correction processing is used as the information included in the accessory information 18 included in the first image data 20. As a result, operation processing related to the white balance can be performed on the processed image data 88 by using the second information 98, as compared to a case where the information included in the accessory information 18 is information completely unrelated to the information related to the gain used in the white balance correction processing. Therefore, with the present configuration, with respect to the color of the image indicated by the second image data 104, it is possible to reduce the influence of the color of the light source of the imaging environment (that is, the color of the environmental light) on the second image data 104.

In the information processing system 10 according to the present embodiment, the second image data 104 is generated by performing the operation using the accessory information 18 included in the first image data 20, on the processed image data 88 included in the first image data 20 (refer to FIG. 7). The teacher data 108 is generated by labeling the second image data 104 generated in this way with the accessory information 18 as the information included in the correct answer data 106 (refer to FIG. 8), and the teacher data 108 is used in the machine learning (refer to FIG. 9). In this way, by using the accessory information 18, it is possible to reduce the variation due to the first image processing 86 (for example, the variation due to the first image processing 86 between different imaging apparatuses) in the color of the image indicated by the second image data 104. Therefore, with the present configuration, it is possible to realize a highly accurate inference by the trained model 116 (refer to FIG. 9), as compared to a case where the labeled second image data 104 is not used as the teacher data for the machine learning.

In the information processing system 10 according to the present embodiment, the second image data 104 is generated by performing the operation using the result of the comparison (for example, the difference 102) between the first information 96 included in the accessory information 18 and the reference color information 100, on the processed image data 88 included in the first image data 20 (refer to FIG. 7). That is, the second image data 104 is generated by correcting the processed image data 88 such that the first information 96 is the reference color information 100. Therefore, as compared to a case where the contents of the image processing of the different imaging apparatuses are not taken into consideration at all, the color standard is unified in the second image data 104, which is suitable for teacher data of AI. Therefore, with the present configuration, it is possible to realize the highly accurate inference by the trained model 116 (refer to FIG. 9), as compared to a case where the labeled second image data 104 is not used as the teacher data for the machine learning.

In the information processing system 10 according to the present embodiment, as described above, even with the plurality of second image data 104 based on the plurality of first image data 20 generated by imaging apparatuses different from each other (for example, between imaging apparatuses having different contents of the image processing), the variation in color between the imaging apparatuses is reduced by making the color of each image indicated by each second image data 104 approximate the reference color. Therefore, as compared to a case where the contents of the image processing of the different imaging apparatuses are not taken into consideration at all, the color standard is unified in the second image data 104, which is suitable for teacher data of AI. Therefore, in the information processing system 10 according to the present embodiment, the machine learning is executed by using the teacher data 108 including the second image data 104. Therefore, with the present configuration, it is possible to obtain the trained model 116 capable of realizing the highly accurate inference, as compared to a case where the machine learning is not executed by using teacher data including the second image data 104.

In the above-described embodiment, the color chart 90 including the 24-colored color patches 90A (refer to FIG. 6) is described, but the technology of the present disclosure is not limited to this, and the number of color patches 90A included in the color chart 90 may be the number (for example, 4096 colors) exceeding 24 colors. Also in this case, as in the above-described embodiment, the color chart information 94 (refer to FIG. 6) and the reference color information 100 (refer to FIG. 7) need only be represented by the signal values of R, G, and B corresponding to the number of the color patches 90A (for example, output values for each pixel of 256 gradations of 0 to 255). Therefore, the color chart information 94 and the reference color information 100 can be created more easily in a case where the color chart information 94 and the reference color information 100 are created by using the signal values than in a case where the color chart information 94 and the reference color information 100 are not created by using the signal values.

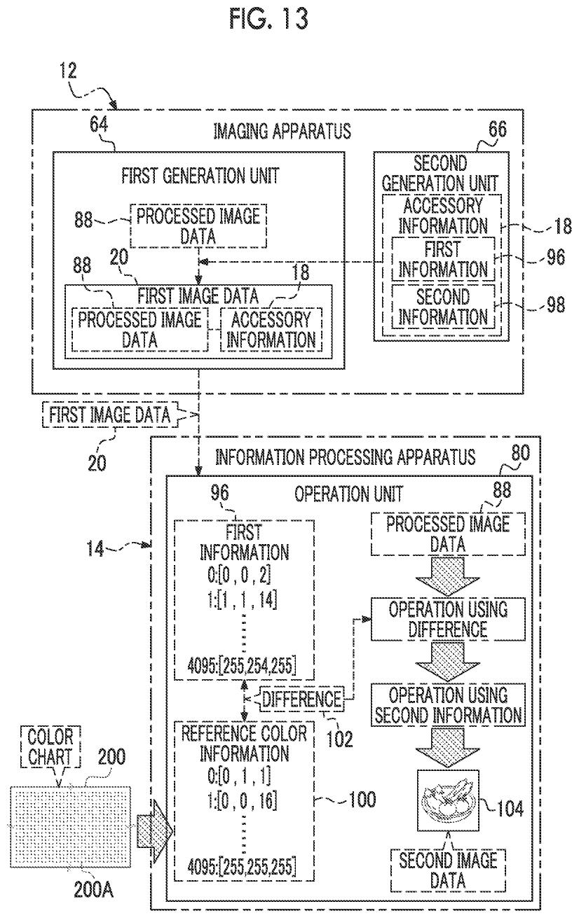

In the above-described embodiment, the color chart information 94 is represented as the signal values of R, G, and B for each of the plurality of color patches 90A (as an example, the 24-colored color patches 90A). In this case, one or two of the signal value of R, the signal value of B, or the signal value of G may be different between the plurality of color patches 90A, and the rest may be the same. As a result, since the color chart information 94 and the first information 96 generated based on the color chart information 94 are detailed information as compared to a case where all of the signal values of R, the signal values of B, and the signal values of G between the plurality of color patches 90A are set to different values, it is possible to grasp the features of the first image processing 86 in detail. Accordingly, the color of the image indicated by the second image data 104 can be made to approximate the reference color by the operation unit 80 accurately, as compared to a case where all of the signal values of R, the signal values of B, and the signal values of G between the plurality of color patches 90A are set to different values. As described above, as shown in FIG. 13 as an example of the color chart information 94, the color chart information 94 and the reference color information 100 are information represented as the signal values of R, G, and B for each of a plurality of color patches 200A.

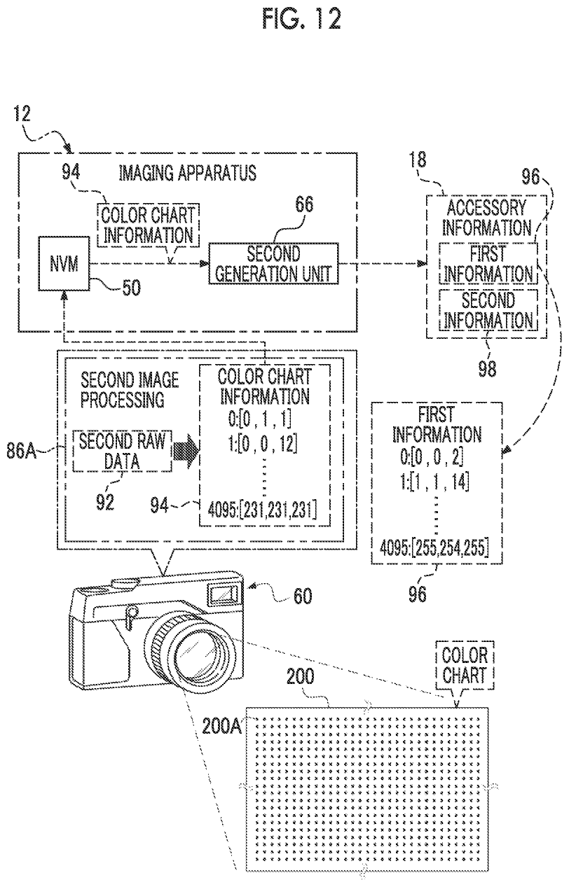

As shown in FIG. 12 as an example, a color chart 200 may be used instead of the color chart 90. The plurality of color patches 200A are arranged on the color chart 200. In the color chart 200, one or two of chroma saturation, lightness, or hue are different between the plurality of color patches 200A, and the rest are the same.

A first example of the color chart 200 is a color chart in which the color patches 200A of the number of patterns in which the chroma saturation is the same between the color patches 200A (for example, one of 256 types of the chroma saturation), the lightness is different therebetween, and the hue is also different therebetween, the color patches 200A of the number of patterns in which the lightness is the same (for example, one of 256 types of the lightness) between the color patches 200A, the chroma saturation is different therebetween, and the hue is also different therebetween, and the color patches 200A of the number of patterns in which hue (for example, one of 256 types of the hue) is the same between the color patches 200A, the chroma saturation is different therebetween, and the lightness is also different therebetween are arranged. A second example of the color chart 200 is a color chart in which the color patches 200A of the number of patterns in which the chroma saturation is the same between the color patches 200A, the lightness is also the same therebetween, and the hue is different therebetween, the color patches 200A of the number of patterns in which the lightness is the same between the color patches 200A, the chroma saturation is also the same therebetween, and the hue is different therebetween, and the color patches 200A of the number of patterns in which the hue is the same between the color patches 200A, the chroma saturation is also the same therebetween, and the lightness is different therebetween are arranged.

As described above, since the color chart 200 is used instead of the color chart 90, the color chart information 94 and the first information 96 generated based on the color chart information 94 are detailed information as compared to a case where all of the chroma saturation, the lightness, and the hue are different between the plurality of color patches 200A, and thus it is possible to grasp the features of the first image processing 86 in detail. Therefore, as compared to a case where all of the chroma saturation, the lightness, and the hue are different between the plurality of color patches 200A, the operation unit 80 can easily cancel the color change due to the first image processing 86, and can make the color of the second image data 104 approximate the reference color accurately. The information corresponding to each color patch 200A in the first information 96 may be indicated by the signal values of R, G, and B as in FIG. 12 as in the above-described embodiment, or may be indicated by the values of the chroma saturation, the lightness, and the hue.

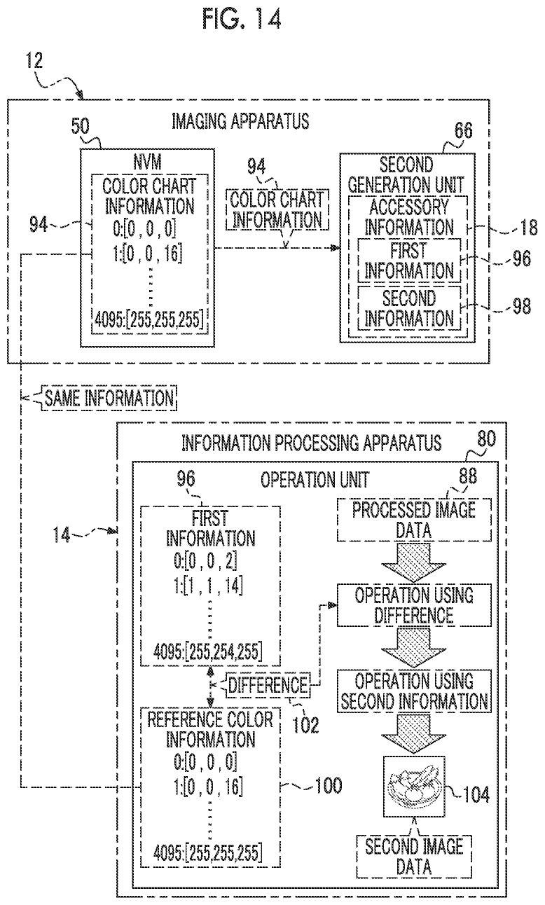

Although the color chart information 94 and the reference color information 100 are different information in the above-described embodiment, as shown in FIG. 14 as an example, the color chart information 94 stored in the NVM 50 of the imaging apparatus 12 may be the same information as the reference color information 100.

Although the color chart information 94 obtained without adding the spectral characteristics of the imaging apparatus 12 (that is, the spectral characteristics of the image sensor 24) is described in the above-described embodiment, but the technology of the present disclosure is not limited to this. For example, the color chart information may be generated based on the color chart 90 and the spectral characteristics of the imaging apparatus 12 (that is, the spectral characteristics of the image sensor 24).

In this case, for example, the second image processing 86A is performed on the RAW data obtained by imaging the color chart 90 via the image sensor 24 of the imaging apparatus 12, to generate the color chart information to which the spectral characteristics of the imaging apparatus 12 are added.

The color chart information thus generated in consideration of imaging apparatus spectral characteristics 118 is used in the same manner as the color chart information 94 described in the above-described embodiment. That is, the second image data 104 is generated by correcting the processed image data 88 such that the color chart information 122 is information related to a predetermined color. As a result, even with a plurality of second image data 104 based on a plurality of first image data 20 generated by imaging apparatuses different from each other (for example, between imaging apparatuses having different contents of the image processing), the variation in color between the imaging apparatuses is reduced by making the color of each image indicated by each second image data 104 approximate the reference color. Therefore, as compared to a case where the color chart information is generated regardless of the imaging apparatus spectral characteristics 118, it is possible to reduce the variation due to the imaging apparatus spectral characteristics 118 (for example, the variation due to the imaging apparatus spectral characteristics 118 between different imaging apparatuses) in the color of the image indicated by the second image data 104.

It should be noted that the color chart information to which the spectral characteristics of the imaging apparatus 12 are added may be stored in advance in the NVM 50, and the processor 48 may acquire the spectral characteristics of the imaging apparatus 12 from the NVM 50 and generate new color chart information by adding the spectral characteristics of the imaging apparatus 12 to the color chart information 94 described in the above-described embodiment.

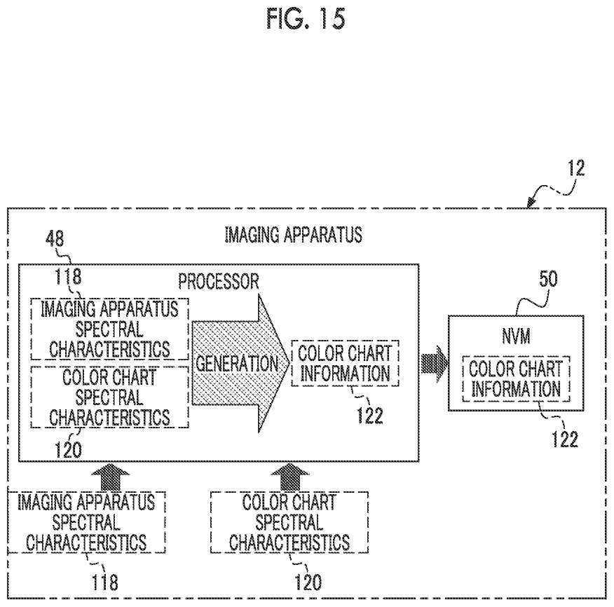

As an example, as shown in FIG. 6, the color chart information 94 may be generated by imaging the color chart 90 via the reference imaging apparatus 60 including an image sensor having the same spectral characteristics as the image sensor 24 of the imaging apparatus 12. The color chart information 94 obtained in this way is information generated based on the spectral characteristics of the imaging apparatus. As shown in FIG. 15, the processor 48 may acquire the imaging apparatus spectral characteristics 118 that are the spectral characteristics of the imaging apparatus 12 and color chart spectral characteristics 120 that are spectral characteristics of the color chart 90 from the outside, to generate the color chart information 122 based on the acquired imaging apparatus spectral characteristics 118 and color chart spectral characteristics 120.

Here, for example, the imaging apparatus spectral characteristics 118 and the color chart spectral characteristics 120 may be acquired from an external device via the external I/F 46, or the imaging apparatus spectral characteristics 118 and the color chart spectral characteristics 120 may be stored in advance in the NVM 50, and the imaging apparatus spectral characteristics 118 and the color chart spectral characteristics 120 may be acquired from the NVM 50.

The color chart information 122 is information obtained by adding the imaging apparatus spectral characteristics 118 and the color chart spectral characteristics 120 to the color chart information 94 described in the above-described embodiment. The processor 48 causes the NVM 50 to store the generated color chart information 122.

The color chart information 122, which is stored in the NVM 50 and is based on the information on the spectral characteristics of the imaging apparatus, is used in the same manner as the above-described embodiment. That is, the second image data 104 is generated by correcting the processed image data 88 such that the color chart information 122 is information related to a predetermined color (for example, the reference color information 100). Therefore, with the present configuration, as compared to a case where the color chart information is generated regardless of the imaging apparatus spectral characteristics 118 and the color chart spectral characteristics 120, it is possible to reduce the variation due to the imaging apparatus spectral characteristics 118 (for example, the variation due to the imaging apparatus spectral characteristics 118 and the color chart spectral characteristics 120 between different imaging apparatuses) in the color of the image indicated by the second image data 104.

In the above-described embodiment, as an example of the image processing information used to generate the first information 96, the WB gain used in the white balance correction processing, the gamma value used in the gamma correction processing, the color reproduction coefficient used in the color correction processing, the conversion coefficient used in the color space conversion processing, the brightness filter parameter used in the brightness filter processing, the first color difference filter parameter used in the first color difference filter processing, the second color difference filter parameter used in the second color difference filter processing, the parameter used in the resize processing, and the parameter used in the compression processing are described, but these examples are merely examples. For example, among these pieces of information, only information that affects the image quality may be used as the image processing information used to generate the first information 96. Information other than these pieces of information (for example, a signal value of optical black used in a case where the offset correction processing is performed on the processed image data 88) may also be used as the image processing information used to generate the first information 96. In the above-described embodiment, although the form example is described in which the second image data 104 is used in the machine learning, the technology of the present disclosure is not limited to this, and the second image data 104 may be used in applications other than the machine learning. For example, the second image data 104 may be stored in a designated storage device (for example, the NVM 50 of the imaging apparatus 12). The second image data 104 may be displayed on a display included in the UI system device 42 (refer to FIG. 2). In this case, for example, the image indicated by the second image data 104 may be simply displayed on the display, the image indicated by the processed image data 88 and the image indicated by the second image data 104 may be displayed on the display in a contrastable state (for example, a state in which the images are arranged in the same screen), or the image indicated by the processed image data 88 and the image indicated by the second image data 104 may be displayed on the display in a state in which one of the image indicated by the processed image data 88 or the image indicated by the second image data 104 is superimposed on the other. Image analysis processing (for example, image analysis processing of an AI method or a template matching method) may be performed on the second image data 104.

In the above-described embodiment, the form example is described in which the machine learning processing is performed by the information processing apparatus 14, the technology of the present disclosure is not limited to this, and at least a part of the machine learning processing (for example, processing by the operation unit 80) may be performed by another apparatus (for example, the imaging apparatus 12).

In the above-described embodiment, the form example is described in which the data generation processing is performed by the imaging apparatus 12, the technology of the present disclosure is not limited to this, and at least a part of the data generation processing (for example, processing by the second generation unit 66) may be performed by another apparatus (for example, the information processing apparatus 14).

In the above-described embodiment, the form example is described in which the processing is performed on the first RAW data 58 in the order of the demosaicing processing unit 64A, the white balance correction unit 64B, the color correction unit 64C, and the gamma correction unit 64D, but this is merely an example, and for example, the order in which the processing is performed on the first RAW data 58 by the demosaicing processing unit 64A, the white balance correction unit 64B, the color correction unit 64C, and the gamma correction unit 64D can be appropriately changed.

In the above-described embodiment, although the form example is described in which the data generation processing program 62 is stored in the NVM 50, the technology of the present disclosure is not limited to this. For example, the data generation processing program 62 may be stored in a portable computer-readable non-transitory storage medium, such as a solid state drive (SSD) or a USB memory. The data generation processing program 62 stored in the non-transitory storage medium is installed on the computer 40 of the imaging apparatus 12. The processor 48 executes the data generation processing in accordance with the data generation processing program 62.

The data generation processing program 62 may be stored in a storage device of another computer or a server apparatus connected to the imaging apparatus 12 via a network, and the data generation processing program 62 may be downloaded in response to the request of the imaging apparatus 12 and installed on the computer 40.

It should be noted that it is not necessary to store the entire data generation processing program 62 in the storage device of the other computer or the server apparatus connected to the imaging apparatus 12 or in the NVM 50, and a part of the data generation processing program 62 may be stored.

Although the computer 40 is built in the imaging apparatus 12 shown in FIG. 2, the technology of the present disclosure is not limited to this, and for example, the computer 40 may be provided outside the imaging apparatus 12.

In the above-described embodiment, the computer 40 is described, but the technology of the present disclosure is not limited to this, and a device including an application specific integrated circuit (ASIC), a field-programmable gate array (FPGA), or a programmable logic device (PLD) may be applied instead of the computer 40. A combination of a hardware configuration and a software configuration may be used instead of the computer 40.

Various processors shown below can be used as hardware resources executing the data generation processing described in the above-described embodiment. Examples of the processor include a CPU which is a general-purpose processor functioning as the hardware resource executing the data generation processing by executing software, that is, a program. Examples of the processor include a dedicated electric circuit that is a processor having a circuit configuration specially designed for executing specific processing, such as an FPGA, a PLD, or an ASIC. A memory is built in or connected to any processor, and any processor also executes the data generation processing by using the memory.

The hardware resources executing the data generation processing may be configured by one of these various processors, or may be configured by a combination of two or more processors of the same type or different types (for example, a combination of a plurality of FPGAs or a combination of a CPU and an FPGA). The hardware resource executing the data generation processing may be one processor.

As an example in which the hardware resource is configured by one processor, first, there is a form in which one processor is configured by a combination of one or more CPUs and software, and the processor functions as the hardware resource executing the data generation processing. Second, as indicated by a system-on-a-chip (SoC) or the like, there is a form in which a processor that realizes the functions of the entire system including a plurality of hardware resources executing the data generation processing with one integrated circuit (IC) chip is used. As described above, the data generation processing is realized by using one or more of the various processors as the hardware resources.

As a hardware structure of these various processors, more specifically, an electrical circuit in which circuit elements, such as semiconductor elements, are combined can be used. The above-described data generation processing is merely an example. Therefore, needless to say, unnecessary steps may be deleted, new steps may be added, or the processing order may be changed without departing from the scope of the technology of the present disclosure.

The above-described contents and above-shown contents are detailed description for parts according to the technology of the present disclosure, and are merely an example of the technology of the present disclosure. For example, the above description related to the configuration, function, action, and effect is the description related to the examples of the configuration, function, action, and effect of the parts according to the technology of the present disclosure. Accordingly, it goes without saying that unnecessary parts may be deleted, new elements may be added, or replacement may be made with respect to the above-described contents and the above-shown contents without departing from the scope of the technology of the present disclosure. In order to avoid complication and facilitate understanding of parts according to the technology of the present disclosure, the description related to common technical knowledge or the like that does not need to be particularly described in order to enable implementation of the technology of the present disclosure is omitted in the above-described contents and the above-shown contents.

In the present specification, “A or B” has the same meaning as “at least one of A or B”. That is, “A or B” means that it may be only A, only B, or a combination of A and B. In the present specification, in a case where three or more matters are represented by “or” in combination, the same concept as “A or B” is applied.

All documents, patent applications, and technical standards described in the present specification are herein incorporated by reference to the same extent as in a case where each individual publication, patent application, or technical standard is specifically and individually indicated to be incorporated by reference.

What is claimed is:

1. A data generation method of generating first image data which is image data obtained by imaging a subject via an imaging apparatus and used in machine learning and which includes accessory information, the data generation method comprising:
a first generation step of generating the first image data by performing first image processing via the imaging apparatus; and
a second generation step of generating first information based on image processing information related to the first image processing, as information included in the accessory information.

2. The data generation method according to claim 1,
wherein the first information is information based on color chart information indicating a color chart and the image processing information.

3. The data generation method according to claim 2,
wherein the first information is color information derived from the color chart information.

4. The data generation method according to claim 2,
wherein the color chart information is stored in advance in the imaging apparatus.

5. The data generation method according to claim 2,
wherein the color chart includes a plurality of color patches, and
one or two of chroma saturation, lightness, or hue are different between the plurality of color patches, and the rest are the same.

6. The data generation method according to claim 2,
wherein the color chart information is information in which a plurality of color patches are defined based on a first signal value indicating a first primary color, a second signal value indicating a second primary color, and a third signal value indicating a third primary color.

7. The data generation method according to claim 6,
wherein one or two of the first signal value, the second signal value, or the third signal value are different between the plurality of color patches, and the rest are the same.

8. The data generation method according to claim 2,
wherein the color chart information is information obtained by performing second image processing corresponding to processing of a part of the first image processing, on a color chart imaging signal obtained by imaging the color chart via a reference imaging apparatus.

9. The data generation method according to claim 2,
wherein the color chart information is information generated based on the color chart and spectral characteristics of the imaging apparatus.

10. The data generation method according to claim 9,
wherein the color chart information is information generated based on spectral characteristics of the color chart and the spectral characteristics of the imaging apparatus.

11. The data generation method according to claim 2, further comprising:
a third generation step of generating second image data by performing an operation using a result of comparison between the first information and reference color information indicating a reference color of the color chart, on the first image data.

12. The data generation method according to claim 1, further comprising:
a third generation step of generating second image data by performing an operation using the accessory information, on the first image data.

13. The data generation method according to claim 1,
wherein the first image processing includes white balance correction processing, and
the accessory information includes second information related to a gain used in the white balance correction processing.

14. A learning method using the second image data generated by the data generation method according to claim 11, the learning method comprising:
executing machine learning by using teacher data including the second image data.

15. An imaging apparatus comprising:
an image sensor; and
a processor,
wherein the processor
generates first image data used in machine learning by performing first image processing on an imaging signal generated by imaging a subject via the image sensor, and
generates first information based on image processing information related to the first image processing, as information included in accessory information of the first image data.

16. The imaging apparatus according to claim 15,
wherein the processor generates the first information based on color chart information indicating a color chart and the image processing information.

17. A non-transitory computer-readable storage medium storing a program executable by a computer to perform data generation processing of generating first image data which is image data obtained by imaging a subject via an imaging apparatus and used in machine learning and which includes accessory information, the data generation processing comprising:
generating the first image data by performing first image processing via the imaging apparatus; and
generating first information based on image processing information related to the first image processing, as information included in the accessory information.
